(19) United States
(12) Patent Application Publication
(10) Pub. No.: US 2006/0070034 A1
(43) Pub. Date: Mar. 30, 2006

(54) System and method for creating and restoring a test environment

(75) Inventors: Robert A. Balfe, Tewksbury, MA (US); Toan N. Do, Lowell, MA (US)

Correspondence Address: THOMAS O. HOOVER, ESQ.;BOWDITCH & DEWEY, LLP, 161 Worcester Road, P.O. Box 9320, Framingham, MA, 01701-9320, US

(73) Assignee: International Business Machines Corporation, Armonk, NY (US)

(21) Appl. No.: 10/951,568

(22) Filed: Sep. 28, 2004

(51) Int. Cl. G06F 9/44

(52) U.S. Cl. 717/124

(57) ABSTRACT

A system and method for creating a test environment on a computer system using an application programming interface (API) is provided. The system and method further let an operator restore the tested computer system to its pre-test configuration after testing is completed. The system and method use an XML based syntax for defining the environment on the computer system. In addition, test parameters and data are defined by the XML syntax. When testing is completed, the XML syntax is used to restore the computer system to its pre-test configuration.

### BACKGROUND OF THE INVENTION

Management and workflow collaboration software systems are used by organizations to maintain the efficiency of workforces. Among other things, these systems, herein referred to as management systems, allow employees to communicate, obtain information, requisition products and services, generate documents, and perform online training. Management systems may also connect portions of an organization that are separated geographically. As a result, management systems are often spread across multiple servers coupled to the network. The distributed nature of management systems along with the requirement that they perform numerous and often times complex operations simultaneously makes them very large and difficult to test and trouble shoot.

Adding to the complexity of management systems is the fact that many of these systems have evolved over time. This evolution has largely been driven by customer needs and has resulted in rather basic management systems evolving into the large, complex ones predominant today. In addition, users must be able to write their own software applications to extract maximum utility from management systems. The combination of old and new system software executable instructions and customer developed software instructions may further contribute to software environments that are difficult to troubleshoot. For example, an enterprise, or management system may be executing hundreds or thousands of software agents and instructions as a matter of normal operation. A software agent as used herein refers to any self-contained potentially adaptive software application or an executable sequence of instructions, typically written by an end user. These software agents can be short lived, i.e. having lifetimes of less than a second, or can be long-lived having lifetimes measured in hours or days. Some of these software agents may need to operate according to a schedule, while others may be event driven. If software agents are not properly written, they may fail to operate at scheduled times, may fail to start when a triggering event occurs, may operate in infinite loops, run too long, or consume too many system resources such as memory.

End users may also write software instructions for performing input/output interactions with the management system. And, users may write applications making use of templates for facilitating usage of forms and data entry associated with the management system. Template-driven applications refer to software enabled applications which are primarily document based when they are accessed, edited or created. Examples of template-driven applications are, but are not limited to, spread sheets, database user interfaces, on-line requisition forms, personnel data input screens, and the like.

In many situations, these user developed software applications must be tested for suitability in addressing their intended purposes and for troubleshooting applications that are not operating properly. In some environments, individuals performing software testing are not experienced software developers; and therefore, they may not be capable of operating sophisticated software debugging tools such as those used by experienced computer programmers.

Performing software testing associated with management systems may require that a user, such as a quality engineer, duplicate the environment in which a software application will be used in order to test the software application. In addition, the quality engineer may need to populate the duplicate environment with data, representative of actual data used in the application, to facilitate meaningful testing. By way of example, if a quality engineer is testing an email application for use in a management system, he/she may need to create thousands of user accounts spread across multiple hardware platforms. In addition, the quality engineer may need to populate the user accounts with sent and received messages of varying sizes and formats. When the quality engineer is finished with testing, he/she may need to restore the system to its state prior to testing. In the above example, the quality engineer may have populated actual user accounts with messages in order to test a new email server configuration, and after confirming that the server configuration operated correctly, the quality engineer may wish to remove only the messages employed during testing. Prior art systems and methods may not allow users, such as quality engineers, to easily and accurately scrub test data and restore system functionality to pre-testing configurations.

What is needed is a tool that lets non-programmers delete test logic and test environments after testing of complex software applications. In addition, such a tool should not adversely impair or impact the software applications that were tested once the application environment has been restored to its pre-tested state.

### SUMMARY OF THE INVENTION

The foregoing and other features and advantages of the system and method for client and template validation will be apparent from the following more particular description of preferred embodiments of the system and method as illustrated in the accompanying drawings in which like reference characters refer to the same parts throughout the different views. The drawings are not necessarily to scale, emphasis instead being placed upon illustrating the principles of the invention.

[TO BE COMPLETED AFTER CLAIMS ARE FINALIZED]

### BRIEF DESCRIPTION OF THE DRAWINGS

FIG. 1 contains a flow chart illustrating a method creating a test environment and for restoring the environment in accordance with a preferred embodiment of the invention;

FIG. 2A illustrates a schematic representation of a system useful for practicing embodiments of the invention;

FIG. 2B illustrates a schematic representation of a management system that can be used when practicing a preferred embodiment of the invention;

FIG. 3 illustrates a hierarchical relationship showing object relationships;

FIGS. 4A-4H contain flow charts illustrating a method for practicing a preferred embodiment of the invention;

FIGS. 5A-5J illustrate exemplary user interfaces for use when practicing embodiments of the invention; and

FIGS. 6A and 6B illustrate a schematic representation of a general purpose computer architecture useful for practicing embodiments of the invention.

### DETAILED DESCRIPTION OF THE INVENTION

Embodiments of the invention let a user, such as a quality engineer, create test environments and populate these environments with data for testing software/hardware systems such as, for example, management systems. In addition, embodiments make it easy for the user to scrub, or remove, test data and test software so that the system can be restored to its pre-test state. Furthermore, the embodiments make it possible for the user to re-use test routines and test data for subsequent system testing. In addition, test routines and test data can be updated without requiring that the user employ complex and time consuming dedicated test configuration management applications. Test routines and test data employed by the invention can be input to automated test solutions such as, for example, SILK.

SILK is a general-purpose simulation and testing language based on the Java™ programming language, and it lets a user create reusable object-oriented simulation/test components and models. SILK is Java based and supports multi-threaded execution which makes it useful for testing and simulating large scale multi-user applications such as enterprise management systems.

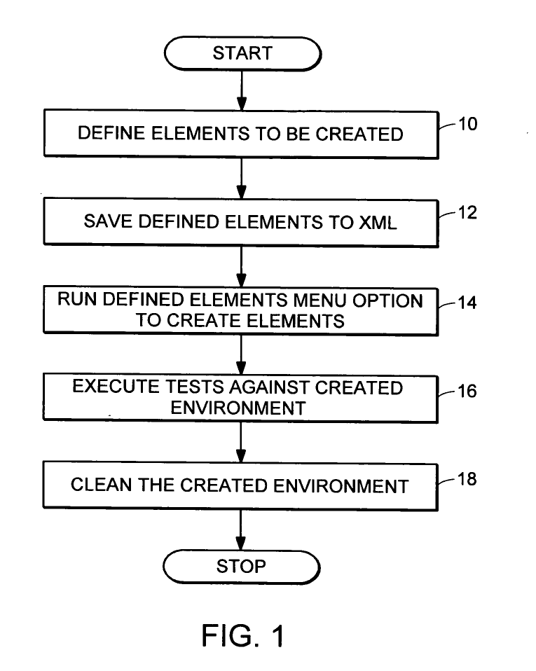

FIG. 1 is a flow chart showing a method for configuring and running an environment creation and cleanup utility. The method begins when elements are defined for the environment under test (per step 10). After elements are defined, they are saved in an extensible markup language (XML) compatible syntax (per step 12). A defined elements menu option is run to create the elements that are used in the environment under test (per step 14). The created elements are typically specific to a given test environment. As such, these elements may be dictated by conventions and formats associated with the operating system, applications running on the operating system or by processes interacting therewith. Tests are executed against the created environment according to specified testing criteria (per step 16). After testing is completed, the created environment is cleaned (per step 18). A cleaned test environment is in substantially the form it was in prior to testing in that all test data has been removed, system parameters and settings have been restored to pre-test values, and test algorithms and test specific function-executable code have been removed from the system.

Systems and methods consistent with preferred embodiments can operate in essentially any computer hardware and software environment. For example, embodiments can be employed for testing Windows™ based personal computers in standalone or networked environments, Solaris™ or AIX™ based work stations operating alone or in a networked environment, and mainframe computers. In addition, embodiments can be employed in distributed applications operating across a plurality of computer platforms and networking components. One such distributed application environment is that of an enterprise management system such as Lotus Notes™ marketed by International Business Machines Corporation (IBM). By way of illustrative example, a Lotus Notes environment will be used when discussing preferred embodiments of the invention herein; however, it should be understood that Lotus Notes is not a limiting example since other embodiments can be used in conjunction with other applications and/or environments without departing from the spirit and scope of the invention.

Preferred embodiments operate at the application programming interface (API). An API is the specific method prescribed by a computer operating system or by an application program by which a programmer writing a software application program can make requests of the operating system or another application. As such, an API is distinguishable from direct user interfaces such as graphical user interfaces (GUI) or a command interface. An API typically provides a set of commonly used functions which can be used by programmers to achieve a level of abstraction between higher level and lower level software agents or software objects.

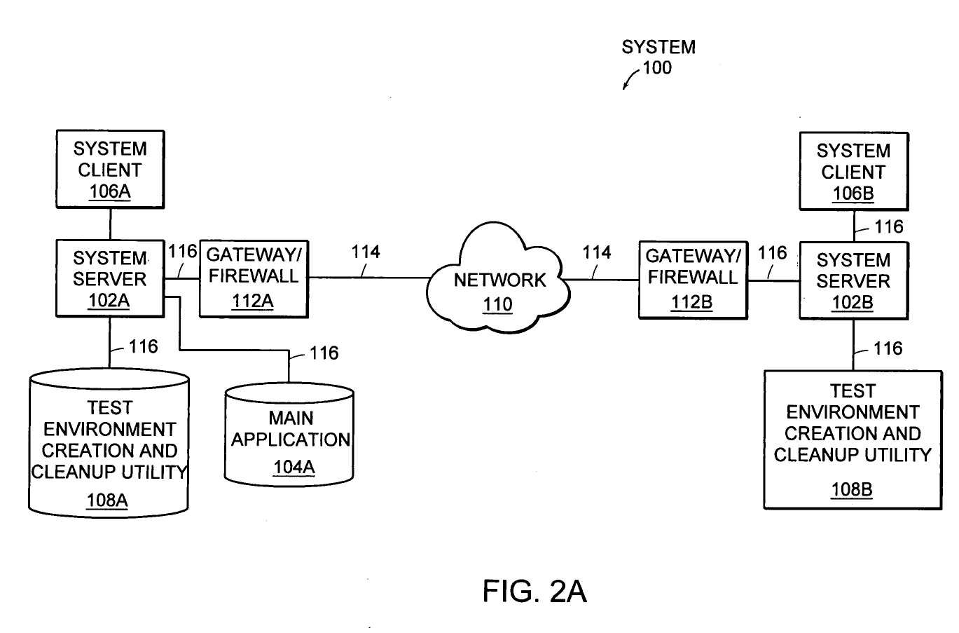

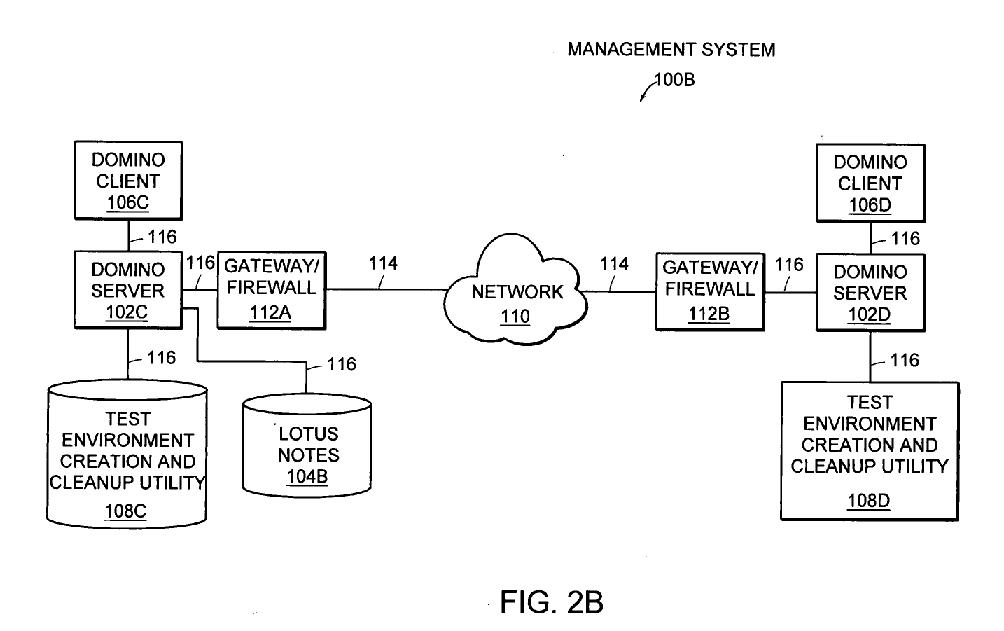

FIG. 2A illustrates an exemplary configuration for a system 100 in accordance with a preferred embodiment. System 100 may include one or more servers 102A, 102B running one or more software applications 104. Examples of software applications that may be run on system 100 are, but are not limited to, database applications, scheduling applications, order fulfillment applications, data collection and processing applications, data communication applications, and control systems.

Servers 102A, 102B are coupled to clients 106A, 106B, respectively. Clients 106A, 106B and servers 102A, 102B may also interact with a test environment creation and cleanup utility 108A, 108B, hereinafter referred to as “Utility 108”, which is used to create a test environment for testing applications running on system 100. Utility 108 uses an XML based syntax that facilitates creation of test environments and then facilitates restoration of system 100 to its pre-test configuration once testing is complete.

Network 110 may be used for communicatively coupling elements of system 100. Network 110 may be any type of communications network running any networking protocol. For example, network 110 may be an intranet such as a local area network (LAN) operating within a corporate location or university campus, a metropolitan area network (MAN) operating within a geographic region such as a city and its surrounding suburbs, or a wide area network (WAN) such as the world wide web. In addition, network 110 may run any type of networking protocol such as, for example, transmission control protocol and Internet protocol (TCP/IP), asynchronous transfer mode (ATM), synchronous optical network (Sonet), frame relay, integrated services digital network (ISDN), and open shortest path first (OSPF). Network 110 may employ a plurality of links 114 for coupling network elements and locations. Links 114 may include hardwired links and/or wireless links. Examples of hardwired links include, but are not limited to, coaxial cable, twisted pair cable, and optical fibers; and examples of wireless links include, but are not limited to, radio frequency (RF) such as IEEE 802.11 based links, or free space optical links.

System 100 may also include gateways and/or firewalls 112A, 112B for providing access to network 110 and for providing protection against undesirable network traffic such as denial-of-service attacks and network traffic containing malicious code such as computer worms and viruses. Links 116 are used to connect elements on the protected side of gateway/firewall 112A and 112B. The implementation of management system 100 shown in FIG. 2A is illustrative; therefore, other implementations of system 100 can be employed without departing from the spirit of the invention. For example, a system 100A may consist of a management system for facilitating workforce collaboration.

FIG. 2B illustrates a preferred embodiment consisting of a management system 100A. Management system 100 may include one or more servers, here Domino™ servers 102C, 102D running at least one version of a workforce collaboration application such Lotus Notes™, hereinafter Notes, 104B. In the embodiment of FIG. 2B, one version of a workforce collaboration software application, here Notes is running in connection with server 102C; however, in other implementations, server 102D may also have a local version of Notes instead of operating off the version associated with server 102C by way of network 110. Lotus Notes™ is produced and distributed by International Business Machines Corp. (IBM) and it includes software and/or hardware for implementing a workforce collaboration and communications environment.

Servers 102C, 102D are coupled to clients 106C, 106D, respectively, which may be Domino clients and are hereinafter generally referred to as Clients 106. Management system 100B may further include one or more test environment creation and cleanup utilities 108C and D, respectively. Utilities 108C and D facilitate application programming interface (API) layer based testing of management applications developed for use on Clients 106 using an XML based syntax.

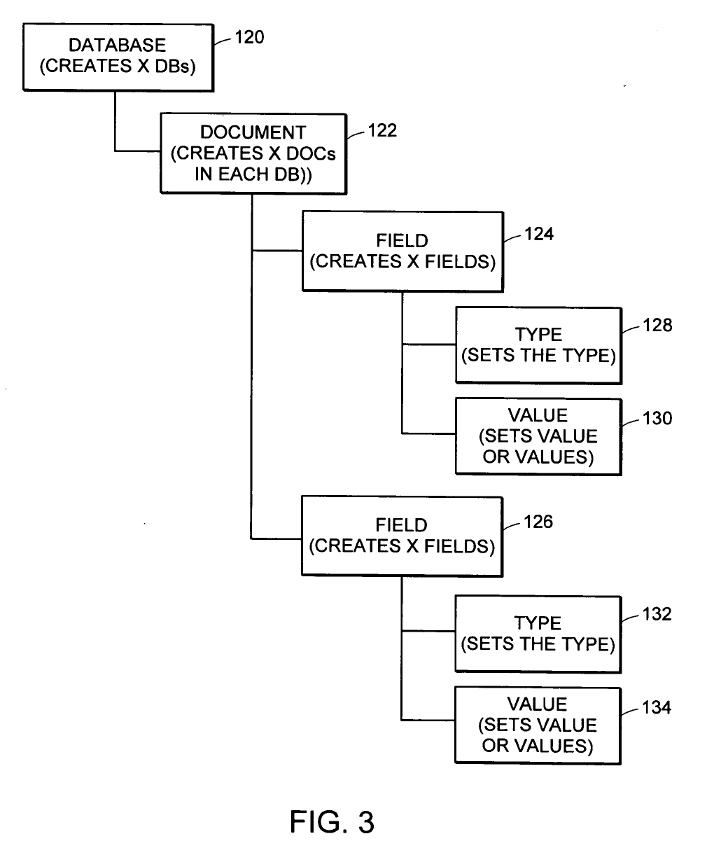

FIG. 3 contains a schematic representation of an exemplary relationship of nested software objects that can be used for creating a test environment. These objects are made up of XML code which is saved as a file and made available to hardware and software components during testing. The use of XML makes it possible to have a data driven test environment creation and cleanup utility that can be run across essentially any computer platform. The utility treats software elements as objects represented by XML code. These objects can stand alone or be nested with other objects. By way of example, a database object 120 may be created. In FIG. 3, database object 120 is the parent object since it represents the highest level of abstraction.

Database object 120 may be populated with one or more documents 122. Since document 122 is represented one layer below database object 120, it is a child object. Document 122 may contain a plurality of fields 124 and 126, respectively, as grand children. Fields 124 and 126 may contain other lower level software objects such as type 128, 132 and value 130, 134. When a test environment is created for database 120, document 122, fields 124 and 126, types 128 and 132, and values 130 and 134 may be populated with test data. After testing is completed, test data can be deleted from the nested objects of FIG. 3 such that the database 120 is returned to its pre-test state. Returning database 120 to its pre-test state may include replacing test data with operational data that resided in database 120 before the test environment was created. The objects in FIG. 3 may have one or more attributes associated therewith. As used herein, an attribute is a complex object that can be defined by itself or by itself and a list of attributes that can complement it. An object may have properties that future attributes can modify or that may be set before or after the object is created.

Since the Utility operates at the API, it is beneficial to have it load at application, or system, startup and to be available to all applications running on system 100A. The Utility is loaded as a dynamic linking library (DLL) in a preferred embodiment. A DLL is a binary file containing functions which are called by one or more processes operating on a computer. A DLL is loaded into system memory at system startup, or at the startup of a particular software application. Once a DLL is loaded, multiple applications can access it simultaneously. For example, if a database application, such as that of FIG. 3, has three modules input, output and processing, respectively, that need to access a database, a programmer can write a DLL for handling communication to the database. The three modules can then call the DLL to communicate with the database. Use of a DLL lets the Utility have access to internal system memory as well as to the structure of the memory.

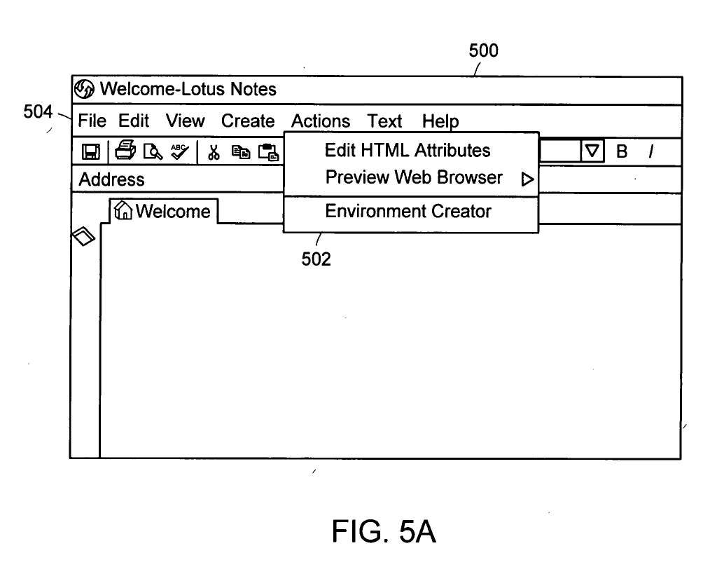

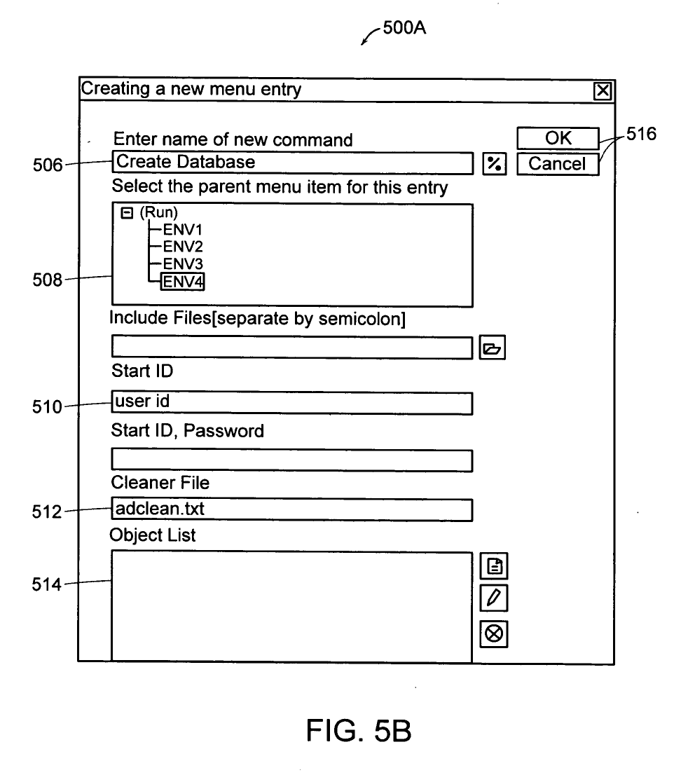

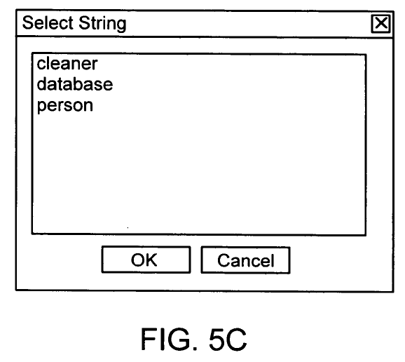

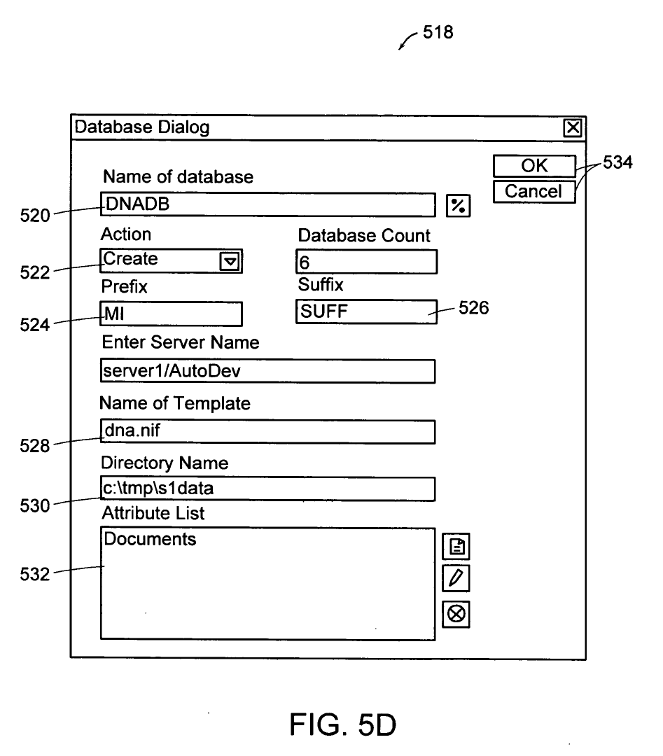

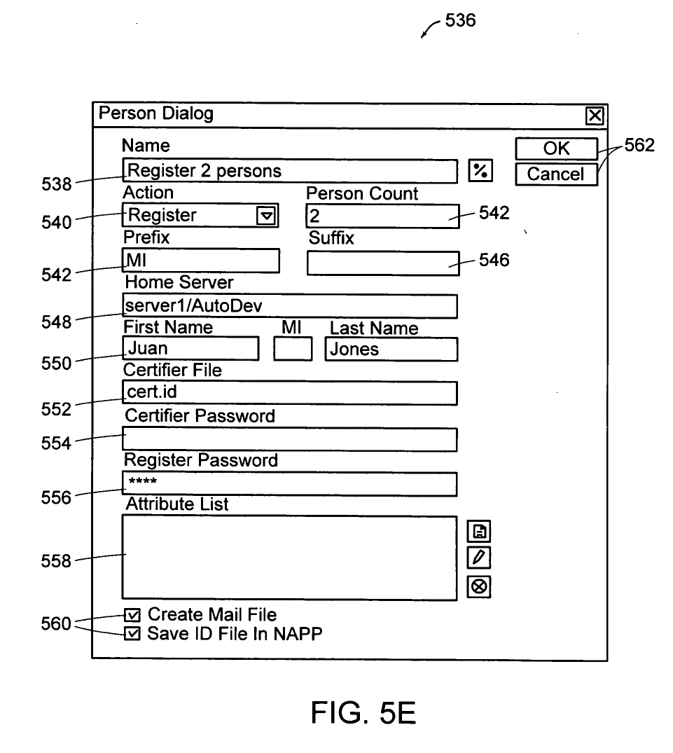

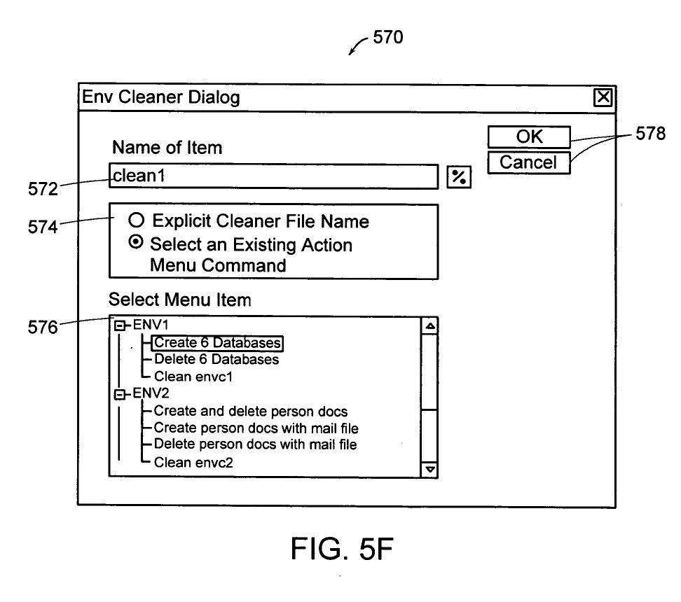

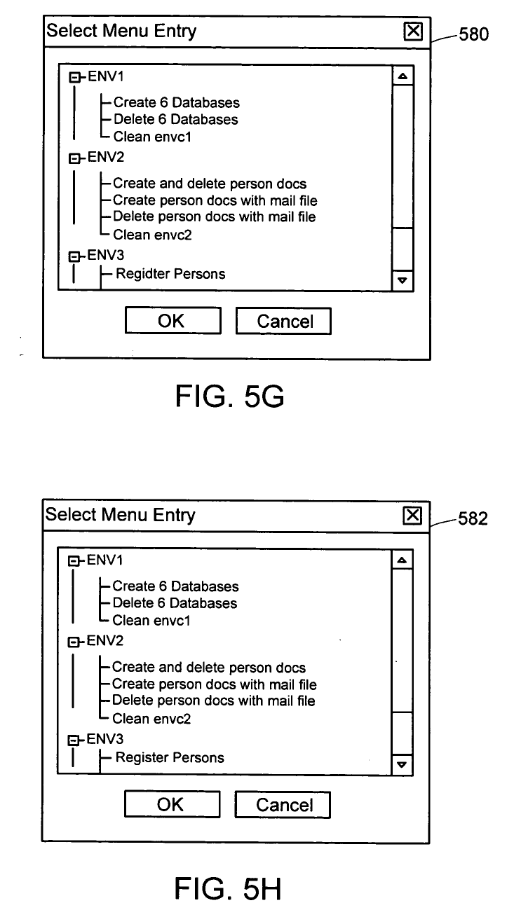

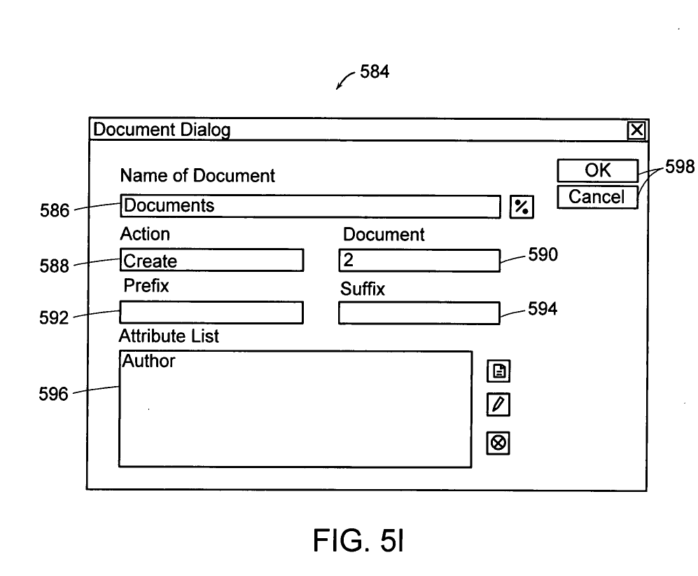

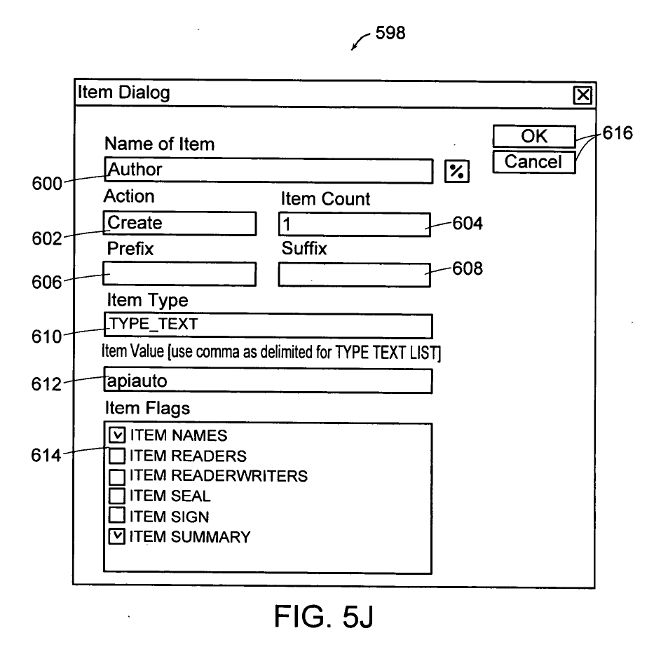

In an alternative embodiment, the Utility can be implemented as an executable, or .exe, file. Once an XML file is created and associated with one or more objects, it may be launched using a GUI or by way of a command line interface, such as Microsoft DOS™. For example, a user can use a GUI based tool to generate an XML file. Then the XML file can be distributed across a plurality of platforms such as, for example, a personal computer operating system such as Windows™, Apple Computing's MAC OS™ operating system, Sun Microsystems Solaris™ operating system, and the like, for execution by way of a command line instruction. Alternatively, the system 100B may generate the XML or an application such as SILK can generate XML. In addition, XML may be used to perform functions such as serializing the display of pop up windows such as those shown in FIGS. 5A-5J.

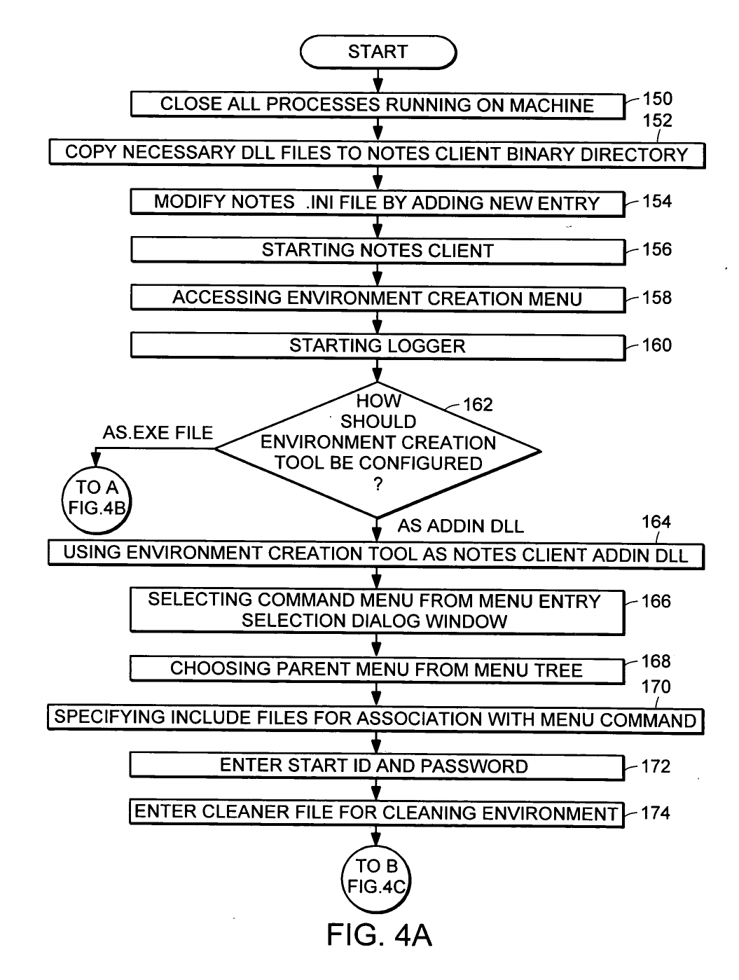

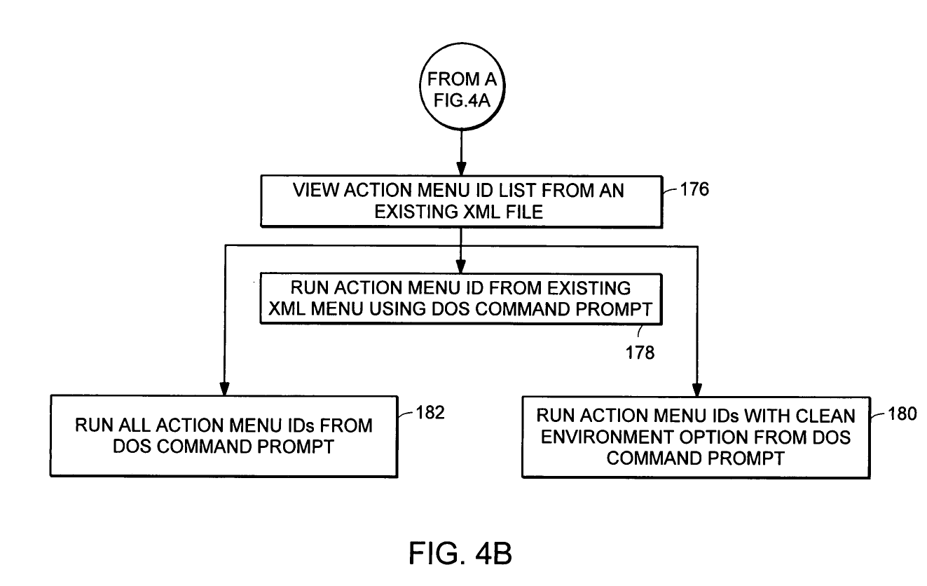

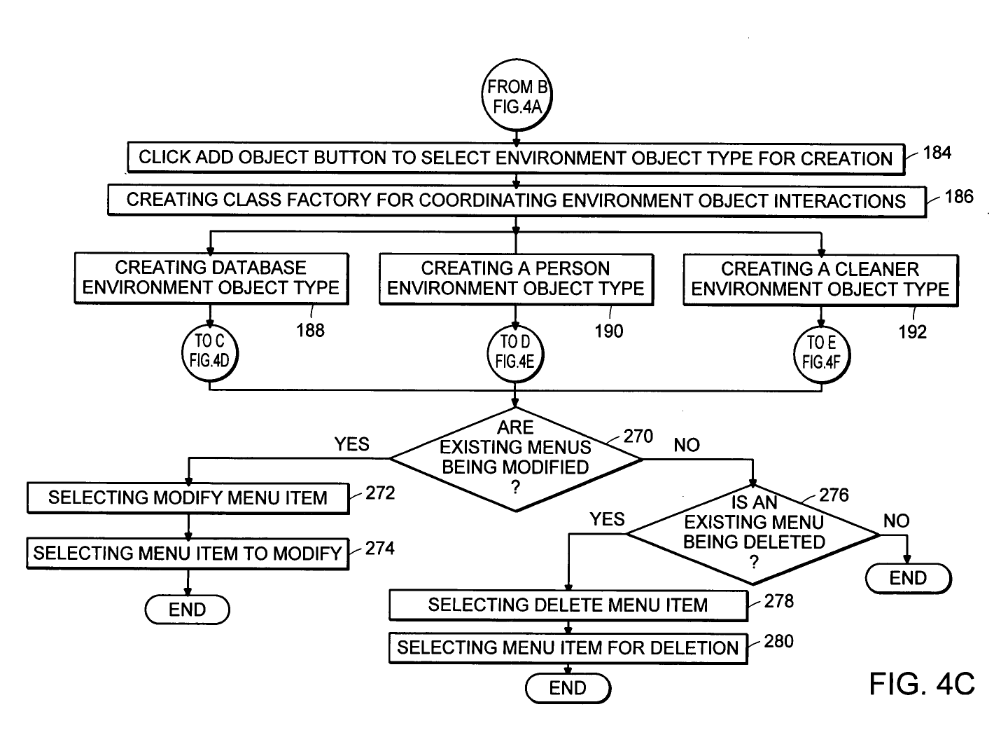

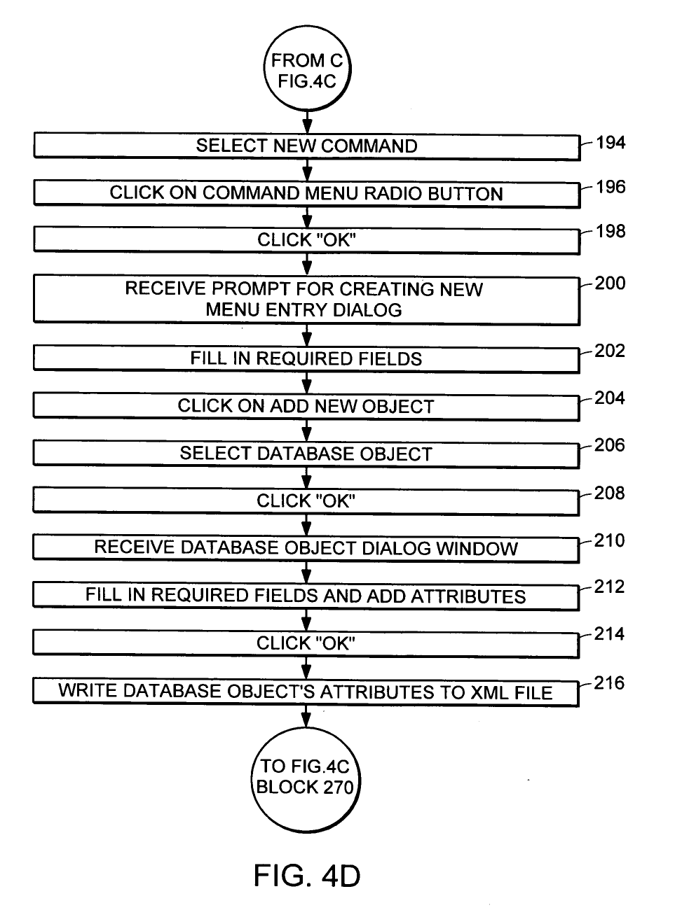

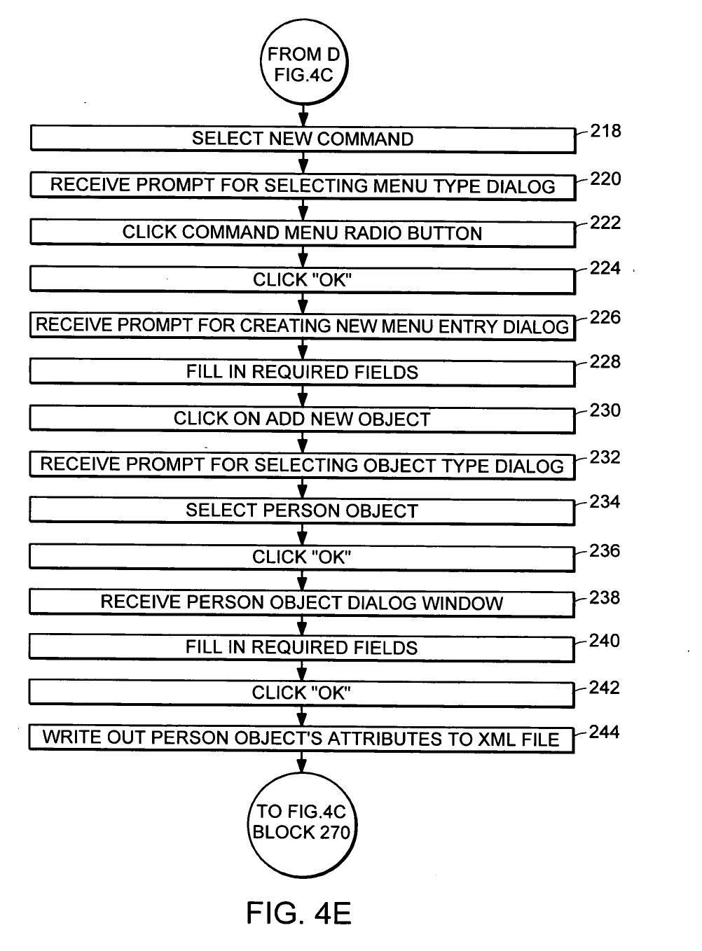

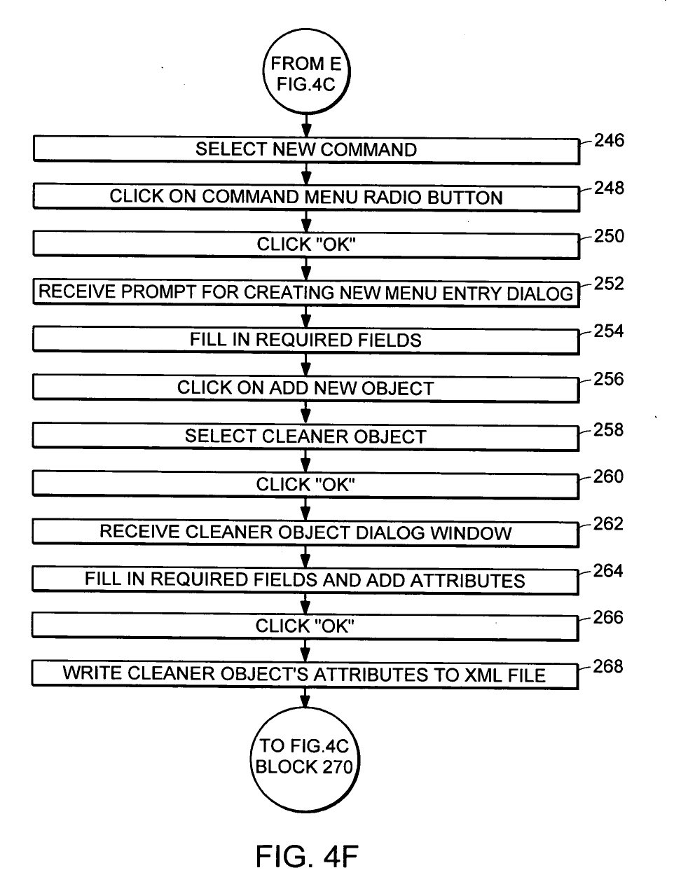

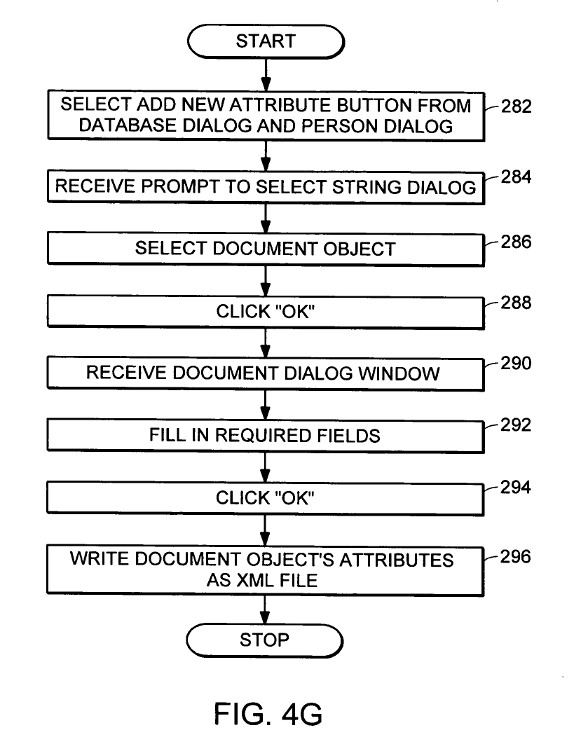

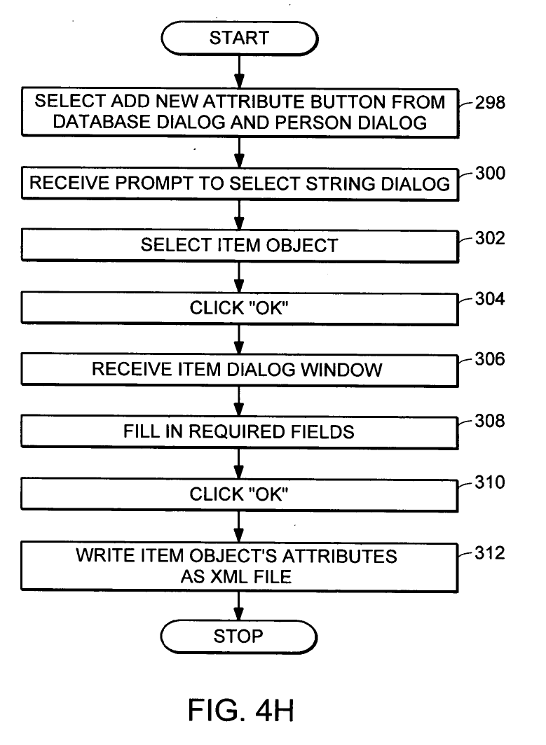

FIGS. 4A-4H illustrate an exemplary method for practicing a preferred embodiment of the invention running in a Lotus Notes environment. In FIG. 4A, a user closes all processes running on the system that will undergo testing (per step 150). Necessary DLL files are copied to a binary directory on a Notes client (per step 152). For example, nenvc.dll, nadvutil.dll, nadvutil.lib, ndvutil32.dll and nadvutil32.lib may be copied to the Notes client. Then the Notes .ini file may be modified by adding a new entry for the Utility such as, for example, Addin Menus=<path>nenuc.dll (per step 154). The Notes client is then started (per step 156). When a user starts the Notes client, an environment creation menu may appear as shown in FIG. 5A.

FIG. 5A illustrates an embodiment of a display 500 illustrating an environment creation menu 502. Display 500 may contain a plurality of action fields 504 which may be selected using an interactive pointing device such as a mouse or trackball. When an action field 504 is selected, a drop down menu 502 may appear. The user may select an item from drop down menu 502 for activation on the client system.

Returning to FIG. 4A, the user can access the environment creation menu shown in FIG. 5A (per step 158). Upon activation of the environment creation menu, a logger may begin running (per step 160). The method may then request user input regarding configuration of the environment creation tool (per step 162).

If the environment creation tool should be configured as a .exe file, the method goes to “A” in FIG. 4B. In FIG. 4B, the user may view an action menu ID list from an existing XML file (per step 176). By way of example, a user may copy envc.exe, nenvc.dll, nadvutil.dll, nadvutil.lib, nadvutil32.dll and nadvutil32.lib to their Notes client binary directory. Then the user may enter envc=<path>notes.ini-file=<path>sample.xml-list from a command line prompt such as DOS. The user then runs the action menu ID from an existing SML menu from the command line prompt by entering envc=<path>notes.ini-file=<path>sample.xml-run=3.5, 7-10 (where 3, 5, 7 are action menu IDs) (per step 178). If the user wants to run all the action menu IDs from the command prompt, the user may enter envc=<path>notes.ini-file=<pth>sample.xml-run=all with-clean option (per step 182). And, if the user wants to run action menu IDs with the clean environment option from the command prompt, the user may enter envc=<path>notes.ini-file=<path>sample.xml-run=3, 5, 7-10-clean (per step 180).

Returning again to FIG. 4A, in contrast, if the environment creation tool should be configured as an Addin DLL in step 164, a command menu is selected from a menu entry selection dialog window (per step 166). Then the user selects a parent menu from a menu tree (per step 168).

A user may specify one or more include files for association with the menu command (per step 170). For example. Include files having # define in the header file may be associated with the menu command. Continuing with the example, a user can use MY_DATABASE_NAME value which may be defined in the header file for Database Name by way of the application. If the user needs to change this Database Name, the user can employ a different header file in which MY_DATABASE_NAME is defined using a different value.

After specifying the include files in step 170, the user may enter a start ID and password, if required (per step 172). Next, the user enters the name of the Cleaner File for cleaning the environment after testing is complete (per step 174).

Now referring to FIG. 4C, the user may click on an Add Object button to select an environment object type to create from the Object Selection Dialog (per step 184). A class factory is then created for coordinating environment object interactions (per step 186). The user may then create a database environment object type (per step 188), a person environment object type (per step 190), or a cleaner environment object type (per step 192).

If the user selects creating a database environment object type, the method goes to FIG. 4D. Referring now to FIG. 4D, the user may select a new command (per step 194) by clicking on, for example, a command menu radio button (per step 196). The user may then click OK using a pointing device (per step 198). The user receives a prompt for creating a new Menu Entry Dialog (per step 200).

FIG. 5B illustrates an exemplary display 500A showing a menu creation interface. Display 500A includes a new command field 506 for associating a user defined name with a command. A parent menu selection window 508 allows the user to select an environment from the menu tree. Start ID field 510 contains an identifier for the user and cleaner file field 512 contains a file name associated with the code making up the cleaning file. An object list field may also be provided for allowing user defined objects. Radio buttons 516 may be activated using an input device. OK causes the client to accept data contained in the fields of display 500A, while Cancel causes the entered data to be discarded.

Returning to 4D, the user fills in required fields using an input device such as a keyboard (per step 202). Then the user clicks on Add New Object which prompts the user to select the object type from a pop up window (per step 204). An exemplary pop up window is shown in FIG. 5C.

Next the user selects a database object (per step 206) and clicks OK (per step 208). Then a Database Object Dialog window is presented to the user as shown in FIG. 5D (per step 210).

FIG. 5D contains an exemplary Database Object Dialog window 518. The window 518 contains, among other things, a database name field 520, an action field 522, a template field 528, a directory name 530 and an attribute list field 532. In addition, window 518 can include radio buttons 534 for saving user data input into the fields or for discarding entered data. The window 518 may also include a prefix field 524 and a suffix field 526 which can be employed in embodiments where a user may perform dbz and/or nls testing.

Returning again to FIG. 4D, the user fills in all required fields and further adds attributes (per step 212). When the user clicks OK in window 518 (per step 214), an XML file is written and it contains the database object's attributes (per step 216). By way of example, the database object's attributes may be written to XML as:

```
    <obj type=“database”action=“Create” count=“1” prefix=“”
suffix=“” name=“creating new database from discsw6.ntf”>
        <servername>server1/AutoDev</servername>
        <template>discsw6.ntf</template>
        <databasename>discw6</databasename>
        <directory></directory>
        <databasetitle>discw6</databasetitle>
        <attributes>
        <attributes>
    </obj>
```

If the user creates a person environment object type in step 190, the method proceeds to FIG. 4E. The method of FIG. 4E substantially follows the flow of FIG. 4D except that the user selects a person object (per step 234) instead of selecting a database object in step 206 of FIG. 4D. The user clicks OK (per step 236) and then receives a Person Object Dialog Window (per step 238).

FIG. 5E illustrates an exemplary Person Object Dialog Window 536. Window 536 includes, among other things, a name field 538, an action field 540, a person count field 542, a prefix field 544, a suffix field 546, a home server field 548, a person name field 550, a certifier file field 552, a certifier password field 554, a register password field 556 and an attribute field 558. In addition, window 536 can include flagged fields which are activated by clicking over them with a pointing device. Examples of flagged fields are Create Mail File and Save ID File in the NAB, collectively 560. When selected, flagged fields may show a check mark or other designator. Window 536 may also include radio buttons 562 for saving data entered by a user.

Returning now to FIG. 4E, the user enters data into required fields (per step 240) and clicks OK (per step 242).

When OK is clicked, the system writes the person object's attributes to an XML file. By way of example, the data from a person object attribute window may be saved in the following format:

```
    <obj type=“person” action=“Register” count=“2”
prefix-“” suffix=“”name=“Registering new users”>
        <homeserver>server 1/AutoDev</homeserver>
        <firstname>Kevin</firstname>
        <middleinitial>M</middleinitial>
        <lastname>Faulk</lastname>
        <certifierfile>cert.id</certifierfile>
        <certifierpassword></certifierpassword>
        <password>password</password>
        <createmailfile>yes</createmailfile>
        <saveidfileinnab>yes</saveidfileinnab>
        <attributes>
        </attributes>
```

If the user desires to create a cleaner environment object type in step 192, the method illustrated in FIG. 4F is used. The method of FIG. 4F substantially follows the flow of FIG. 4D until the user selects a cleaner object (per step 258). After the user selects a cleaner object, OK is selected (per step 260) and the user receives a cleaner object dialog window (per step 262). The user enters data into the required fields and adds necessary attributes (per step 264). After doing so, the user clicks OK (per step 266).

FIG. 5F illustrates an exemplary cleaner dialog window 570 that is presented to the user in step 262. Window 570 includes an item name field 572 and a menu item field 576. In addition, window 570 can include a toggled field 574 wherein the user is forced to have a single item selected. If desired, the system can set a particular item as a default value and allow the user to make a different selection. By way of example, the Utility may select Explicit Cleaner File name in toggle field 574. In FIG. 5F, the user has changed the default by checking Select an Existing Menu Command.

Returning now to FIG. 4F, the cleaner object's attributes are written to an XML field. By way of example, cleaner object's attributes may be written as:

```
<obj type=“cleaner” action=“” count=“0”
prefix=“” suffix=“” name=“Cleanup database”>
        <menuid>8</menuid>
        <cleanerfilepath>adclean2.txt</cleanerfilepath>
        <selectmenu>yes</selectmenu>
        <attributes>
        </attributes>
    </obj>
```

After performing the methods associated with FIG. 4D, 4E or 4F, flow returns to FIG. 4C at the input to step 270.

The Utility determines if existing menus are being modified (per step 270). If an existing menu is being modified, Modify Menu Item is selected by checking on the File menu in the menu bar of the display (per step 272). The user then selects a menu item to modify using a pointing device and clicks OK to enter the selection. FIG. 5G illustrates an exemplary window 580 for selecting a menu entry.

In contrast, a determination is made as to whether an existing menu is being deleted (per step 276) if a pre-existing menu is not being modified in step 270. If an existing menu is being deleted, Delete Menu Item is selected by clicking on File menu in the menu bar (per step 278). Then a menu item for deletion is selected using a point device (per step 280). FIG. 5H illustrates an exemplary display 582 for selecting a menu item for deletion.

FIG. 4G contains a flow chart illustrating an exemplary method for creating a document object as an attribute. The user selects the Add New Attribute button from the Database Dialog display 518 (FIG. 5D) and/or the Person Dialog display 536 (FIG. 5E) (per step 282). The user then receives a prompt to select the string dialog having only document object as the selection (per step 284). Then the user clicks OK (per step 286). A Document Dialog window is presented to the user (per step 290). FIG. 5I illustrates an exemplary Document Dialog display 584. Display 584 includes, among other things, a document name field 586, an action field 588, a document count field 590, a prefix field 592, a suffix field 594 and an attribute list 596. In addition, display 584 may include one or more radio buttons 598 for saving or discarding data entered by the user.

Returning to FIG. 4G, after being presented with the Document Dialog display 584 in step 290, the user fills in all required fields (per step 292) and then clicks OK if the fields contain correct data (per step 294). When OK is clicked, the document object's attributes are written as an XML file. By way of example, an XML file can be written as:

```
    <obj type=“document” action=“Create” count=“1” prefix=“”
suffix=“” name=“create new doc”>
        <attributes>
          <obj type=“notes doc item” action=“Create”
count=“1” prefix=“” suffix=“” name=“Create new item”>
            <itemtype>TYPE_TEXT</itemtype>
            <itemname>Author</itemname>
            <itemvalue>DNA</itemvalue>
            <itemflags>68</itemflags>
            <attributes>
            </attributes>
          </obj>
          <obj type=“notes doc item” action=“Create”
count=“1” prefix=“” suffix=“” name=“Create new number item”>
          <itemtype>TYPE_NUMBER</itemtype>
          <itemname>PortNum</itemname>
          <itemvalue>23333</itemvalue>
          <itemflags>68</itemflags>
          <attributes>
          </attributes>
        </obj>
        <obj type=“notes doc item” action=“Create”
count=“1” prefix=“” suffix=“” name=“Create new data item”>
          <itemtype>TYPE_TIME</itemtype>
          <itemname>DateCreated</itemname>
          <itemvalue>8/28/2003</itemvalue>
```

FIG. 4H contains an exemplary flow chart illustrating a method for creating an item object as an attribute. The user selects the Add New Attribute button from the Database Dialog display 518 (FIG. 5D) and/or the Person Dialog display 536 (FIG. 5E) (per step 298). The user then receives a prompt to select a string dialog having only a Notes document item object to select (per step 300). The user selects the item object (per step 302) and clicks OK (per step 304). The user then receives an Item Dialog Window (per step 306).

FIG. 5J illustrates an exemplary Item Dialog window 598. Item Dialog window 598 includes, among other things, a name field 600, an action field 602, an item count field 604, a prefix field 606, a suffix field 608, an item type field 610, an item value field 612 and an item flag field 614. Item flag field 614 may let a user select only a single selection thereby acting as a toggled field, or item flag field 614 may let a user choose multiple selections. Item Dialog window 598 may further include radio buttons 616 for saving or discarding data entered by the user.

Returning to FIG. 4H, the user fills in required fields in Item Dialog window 598 (per step 308) and clicks OK (per step 310). The item object's attributes are then written as an XML file. By way of example, an item object's attributes may be written as:

```
    <obj type=“notes doc item”action=“Create” count=“1” prefix=“”
suffix=“” name=“create new data item”>
        <Itemtype>TYPE-TIME</itemtype>
        <itemname>DateCreated</itemname>
        <itemvalue>8/28/2003</itemvalue>
        <itemflags>68</itemflags>
        <attributes>
        <attributes>
    </obj>
```

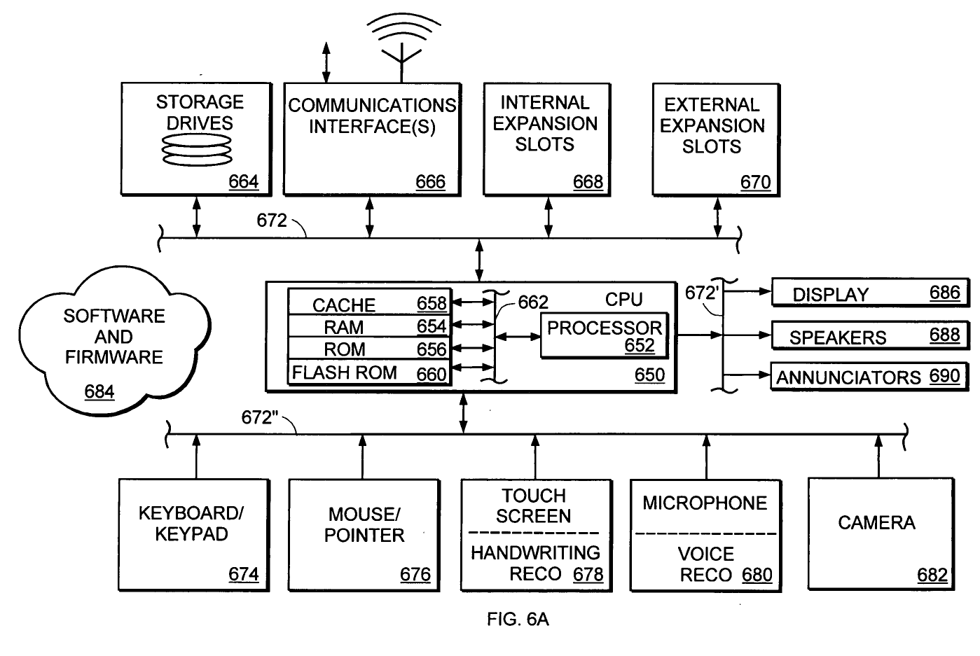

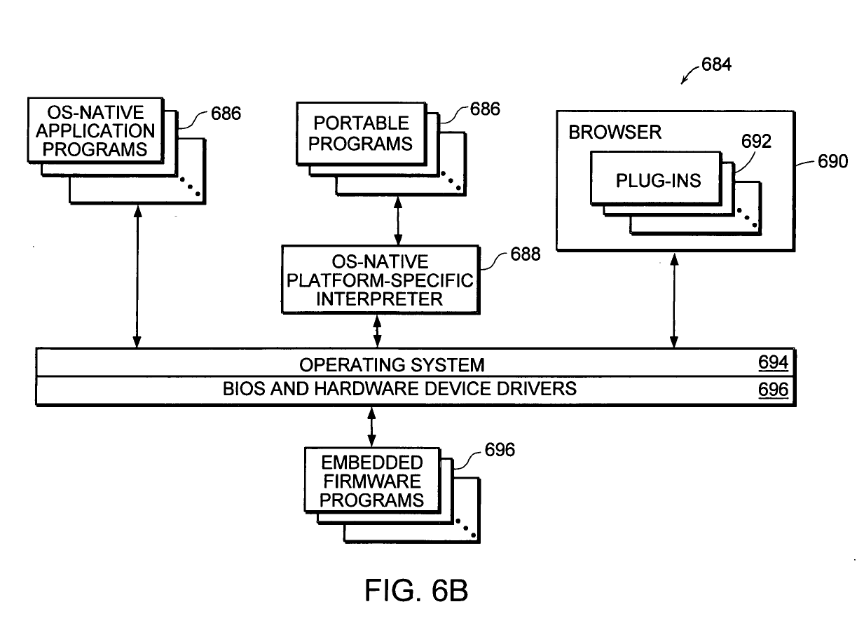

FIGS. 6A and 6B illustrate an exemplary computer hardware architecture and software implementation for various aspects of the invention such as server 102A, 102B and Client 106A, 106B, respectively.

Turning to FIG. 6A, a generalized architecture is presented including a central processing unit 650 (CPU), which is typically comprised of a microprocessor 652 associated with random access memory (RAM) 654 and read-only memory (ROM) 656. Often, the CPU 650 is also provided with cache memory 658 and programmable FlashROM 660. The interface 662 between the microprocessor 652 and the various types of CPU memory is often referred to as a local bus, but also may be a more generic or industry standard bus. CPU 650 processes and interprets machine-readable, or function-executable, instructions associated with an operating system, user-developed applications, validation tools, Notes Clients, Notes servers, and environment creation tools.

Many computing platforms are also provided with one or more storage drives 664, such as a hard-disk drives (HDD), floppy disk drives, compact disc drives (CD, CD-R, CD-RW, DVD, DVD-R, etc.), and proprietary disk and tape drives (e.g., Iomega Zip™ and Jaz™, Addonics SuperDisk™, etc.). Additionally, some storage drives may be accessible over a computer network. The RAM is capable of storing machine-readable instructions and information necessary to operate software applications under test as well as validation and test automation tools.

Many computing platforms are provided with one or more communication interfaces 666, according to the function intended of the computing platform. For example, a personal computer is often provided with a high speed serial port (RS-232, RS-422, etc.), an enhanced parallel port (EPP), and one or more universal serial bus (USB) ports. The computing platform may also be provided with a local area network (LAN) interface, such as an Ethernet card, and other high-speed interfaces such as the High Performance Serial Bus IEEE-1394.

Computing platforms such as wireless telephones and wireless networked PDA's may also be provided with a radio frequency (RF) interface with antenna, as well. And in some cases, the computing platform may be provided with an infrared data arrangement (IrDA) interface, too.

Computing platforms are often equipped with one or more internal expansion slots 668, such as Industry Standard Architecture (ISA), Enhanced Industry Standard Architecture (EISA), Peripheral Component Interconnect (PCI), or proprietary interface slots for the addition of other hardware, such as sound cards, memory boards, and graphics accelerators.

Additionally, many units, such as laptop computers and PDA's, are provided with one or more external expansion slots 670 allowing the user the ability to easily install and remove hardware expansion devices, such as PCMCIA cards, SmartMedia cards, and various proprietary modules such as removable hard drives, CD drives, and floppy drives.

Often, the storage drives 664, communication interfaces 10, internal expansion slots 668 and external expansion slots 670 are interconnected with the CPU 650 via a standard or industry open bus architecture 672, such as ISA, EISA, or PCI. In many cases, the bus 672 may be of a proprietary design.

A computing platform is usually provided with one or more user input devices, such as a keyboard or a keypad 674, and mouse or pointing device 676, and/or a touch-screen display 678. In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch screen 678 is usually provided, often with handwriting recognition capabilities.

Additionally, a microphone 680, such as the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device 682, such as a still digital camera or full motion video digital camera which can be used for employee collaboration such as web conferencing.

One or more user output devices, such as a display 686, are also provided with most computing platforms. The display 686 may take many forms, including a Cathode Ray Tube (CRT), a Thin Flat Transistor (TFT) array, or a simple set of light emitting diodes (LED) or liquid crystal display (LCD) indicators.

One or more speakers 688 and/or annunciators 690 are often associated with computing platforms, too. The speakers 688 may be used to reproduce audio and music, such as the speaker of a wireless telephone or the speakers of a personal computer. Annuciators 690 may take the form of simple beep emitters or buzzers, commonly found on certain devices such as PDAs and PIMs.

These user input and output devices may be directly interconnected (672′, 672″) to the CPU 650 via a proprietary bus structure and/or interfaces, or they may be interconnected through one or more industry open buses such as ISA, EISA, PCI, etc.

The computing platform is also provided with one or more software and firmware 684 programs to implement the desired functionality of the computing platforms.

Turning now to FIG. 6B, more detail is given of a generalized organization of software and firmware 684 on this range of computing platforms. One or more operating system (OS) native application programs 686 may be provided on the computing platform, such as word processors, spreadsheets, contact management utilities, address book, calendar, email client, presentation, financial and bookkeeping programs.

Additionally, one or more portable or device-independent programs 686 may be provided, which must be interpreted by an OS-native platform-specific interpreter 688, such as Java™ scripts and programs.

Often, computing platforms are also provided with a form of web browser or micro-browser 690, which may also include one or more extensions to the browser such as browser plug-ins 692.

The computing device is often provided with an operating system 694, such as, for example, Microsoft Windows™, UNIX®, IBM OS/2™, or AIX®, LINUX, MAC OS™, Sun Solaris™, or other platform specific operating systems. Smaller devices such as PDA's and wireless telephones may be equipped with other forms of operating systems such as real-time operating systems (RTOS) or Palm Computing's PalmOS™.

A set of basic input and output functions (BIOS) and hardware device drivers 696 are often provided to allow the operating system 694 and programs to interface to and control the specific hardware functions provided with the computing platform.

Additionally, one or more embedded firmware programs 696 are commonly provided with many computing platforms, which are executed by onboard or “embedded” microprocessors as part of the peripheral device, such as a microcontroller or a hard drive, a communication processor, network interface card, or sound or graphics card.

As such, FIGS. 2A, 2B, 6A and 6B describe in a general sense the various hardware components, software and firmware programs of a wide variety of computing platforms, including but not limited to personal computers, workstations, servers, Notes Clients, Notes servers, and other like appliances. The present invention will now be described relative to the processes and methods preferably implemented as software and firmware on such a computing platform for validating software applications under test. It will be readily recognized by those skilled in the art that the following methods and processes may be alternatively realized as hardware functions, in part or in whole, without departing from the spirit and scope of the invention.

What is claimed:

1. A method for performing testing on a computer system using an application programming interface, said method comprising the steps of:
defining a plurality of elements to produce a plurality of defined elements, said plurality of defined elements associated with an environment operatively associated with said application programming interface;
saving said plurality of defined elements to an extensible markup language (XML);
creating a set of elements from said plurality of defined elements, said set of elements operatively associated with said environment; and
performing said testing on said system using said set of elements.

2. The method of claim 1 further comprising the step of:
cleaning said environment after said testing has been performed.

3. The method of claim 2 further comprising the step of:
archiving a result, said result associated with said testing.

4. The method of claim 1 wherein said elements are created using a defined elements menu.

5. The method of claim 2 wherein said XML is generated by a user of said system.

6. The method of claim 2 wherein said XML is generated by said system.

7. The method of claim 2 wherein said environment is loaded as a dynamic link library.

8. The method of claim 2 wherein said said environment is launched using a command line prompt.

9. The method of claim 8 wherein said environment interacts with SILK.

10. The method of claim 2 wherein said environment is loaded as an executable file having an .exe extension.

11. The method of claim 3 further comprising the step of:
running a logging function for tracking operation of said environment.

12. The method of claim 2 wherein said XML is used to serialize the rendering of images displayed on a display device.

13. A system for performing software testing using an application programming interface, said system comprising:
a memory for storing elements associated with an environment, said environment operatively associated with said application programming interface for facilitating said software testing on said system; and
a processor communicatively associated with said memory, said processor executing machine-readable instructions for causing said elements to be converted to an extensible markup language for use in performing said software testing.

14. The system of claim 13 wherein said environment is loaded as a dynamic link library.

15. The system of claim 14 wherein said processor further executes machine-readable instructions for cleaning said environment after said software testing has been performed.

16. The system of claim 15 wherein said processor further executes machine-readable instructions for operating a logging function, said logging function for monitoring operation of said environment.

17. The system of claim 15 further comprising:
a network interface for communicatively coupling said system to a network.

18. A method for restoring an operating environment on a computer system, the method comprising the steps of:
starting an operating system on said computer;
accessing an environment creation menu for creating a testing environment on said computer, said testing environment operatively communicating with an application programming interface for facilitating testing of said computer;
accessing an environment creation tool using said environment creation menu, said environment creation tool being accessible by way of a dynamic link library file; and
accessing a cleaner file containing machine-readable instructions for restoring said operating environment after said testing is complete.

19. The method of claim 18 further comprising:
creating an environment object type for use in testing said computer.

20. The method of claim 19 wherein said environment object type is selected from the group having members consisting of a database environment object type, a person environment object type and a cleaner object type.
